(19) United States
(12) Patent Application Publication
(10) Pub. No.: US 2013/0295910 A1
(43) Pub. Date: Nov. 7, 2013

(54) MITIGATING USE OF DEVICE FEATURE DURING VEHICLE OPERATION

(71) Applicants: Don Enty, Colleyville, TX (US); Brett Barta, Hudson, OH (US)

(72) Inventors: Don Enty, Colleyville, TX (US); Brett Barta, Hudson, OH (US)

(21) Appl. No.: 13/939,850

(22) Filed: Jul. 11, 2013

Related U.S. Application Data
(63) Continuation-in-part of application No. 13/431,067, filed on Mar. 27, 2012.
(60) Provisional application No. 61/469,544, filed on Mar. 30, 2011.

(51) Int. Cl. H04W 8/22

(52) U.S. Cl. CPC H04W 8/22
USPC 455/419

(57) ABSTRACT

One or more techniques and/or systems are disclosed for mitigating use of a mobile device feature of a mobile device during vehicle operation a vehicle operation. A determination component coupled with a vehicle can identify a vehicle operation condition, such as whether it is driving or not. A disablement indicator determination can create a first disablement indicator based on the vehicle operation condition. A mobile device communication component that is communicatively coupled with a proximate mobile device can transmit the first disablement indicator to the mobile device. When the mobile device receives the first disablement indicator, a disablement component that is operating on the mobile device can enable a user-interface cover, which mitigates the mobile device user from accessing an activator for a feature on the mobile device.

### CROSS-REFERENCE TO RELATED APPLICATIONS

This application is a continuation-in-part application of U.S. Ser. No. 13/431,067 filed Mar. 27, 2012, which is incorporated herein by reference; which claims priority from a provisional application having U.S. Ser. No. 61/469,544, filed on Mar. 30, 2011, which is incorporated herein by reference.

### BACKGROUND

Transmitting or receiving data, such as text messages, from a mobile device (e.g., “texting”) while operating a moving vehicle can be hazardous to the operator and may cause accidents for other vehicle operators. Due to the known hazards associated with distracted vehicle operation, some jurisdictions have attempted to ban such data transmission and reception, (e.g., texting while driving); however, the practice continues.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, techniques and systems for mitigating use of one or more features of a vehicle operator's mobile device, such as those that may allow the operator to transmit data. A device may be installed in the operator's vehicle, and communicatively paired with the mobile device. The device may be able to detect when the vehicle is in operation, and can communicate with a program loaded onto the mobile device. As a result of the communication with the mobile device, use of one or more features on the mobile device may be mitigated, such as by enabling a cover screen that may not allow the user to access screen enabled ‘buttons.’ During the feature mitigation, the mobile device may still be able to receive data, but the operator may not be able to access the received data, and/or respond.

In one implementation, a vehicle operation determination component that is operably coupled with a vehicle can be configured to identify a vehicle operation condition. Further, a disablement indicator determination component that is operably coupled with the vehicle operation determination component can be configured to identify a first disablement indicator, based at least on the detected vehicle operation condition. A mobile device communication component can be operably coupled with the disablement indicator determination component; and may be configured to communicatively couple with a proximate mobile device, and transmit the first disablement indicator to the mobile device. When the mobile device receives the first disablement indicator, a disablement component that is operating on the mobile device can enable a user-interface cover, where the user-interface cover mitigates a mobile device operator from accessing an activator for a first feature on the mobile device.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a schematic view of an example implementation of one or more portions of one or more systems described herein.

FIG. 2 is a component diagram illustrating an example implementation of one or more systems described herein.

FIG. 3 is a component diagram illustrating an example implementation of one or more systems described herein.

FIG. 4 is a component diagram illustrating an example implementation of one or more systems described herein.

FIG. 5 is a component diagram illustrating an example implementation of one or more systems described herein.

FIG. 6 is a flow chart diagram illustrating an example implementation of one or more portions of one or more techniques described herein.

FIGS. 7A and 7B are schematic views of example implementations of one or more portions of one or more systems described herein.

FIG. 8 is a schematic view of an example implementation of one or more portions of one or more systems described herein.

FIG. 9 is a component diagram illustrating an exemplary system for mitigating use of a mobile device feature of a mobile device during vehicle operation.

FIGS. 10A and 11B are component diagrams illustrating example implementations of one or more portions of one or more systems described herein.

FIGS. 11A and 11B are component diagrams illustrating example implementations of one or more portions of one or more systems described herein.

FIGS. 12A and 12B are component diagrams illustrating example implementations of one or more portions of one or more systems described herein.

FIG. 13 is a component diagram illustrating an example implementation of one or more portions of one or more systems described herein.

FIG. 14 is a flow diagram illustrating an exemplary method for mitigating use of a mobile device feature of a mobile device during vehicle operation.

FIG. 15 is a flow diagram illustrating an example implementation where one or more portion of one or more techniques described herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

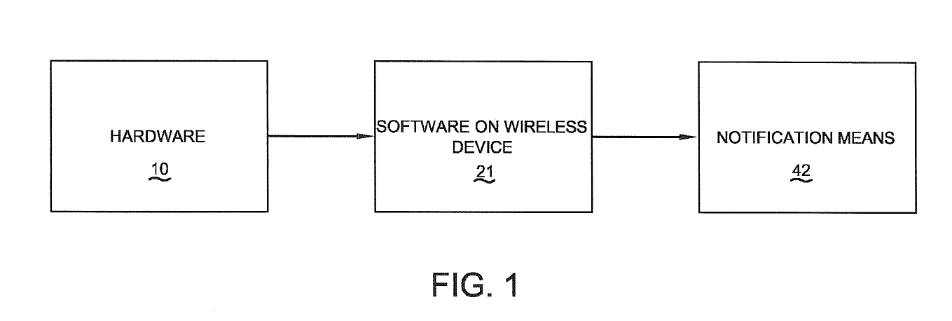

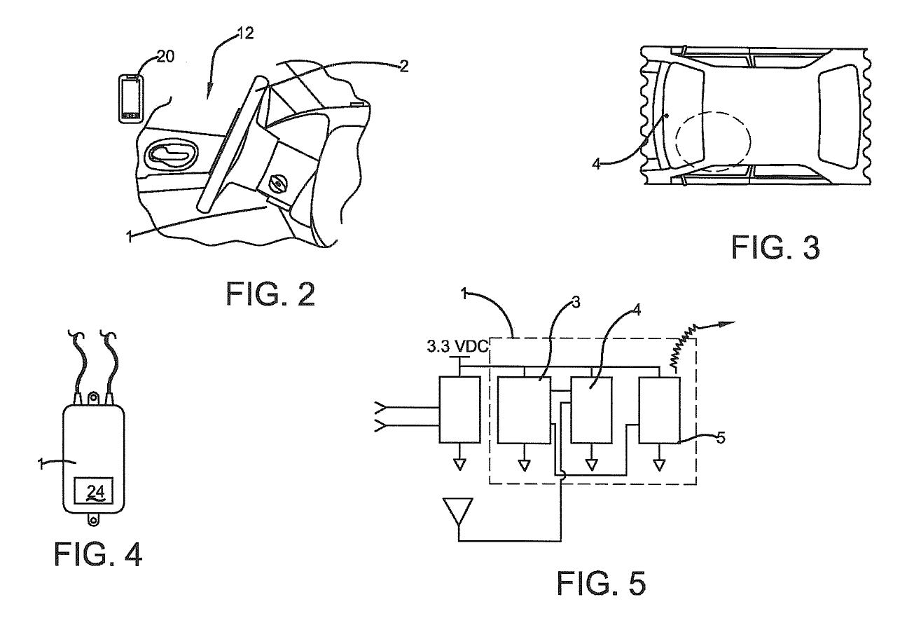

One or more techniques and systems described herein are illustrated in FIGS. 1-8. Techniques and systems described herein can relate to a method and/or apparatus for disabling certain features of a vehicle driver's wireless device 20, such as a cellphone, smartphone, tablet or similar device that is capable of sending or receiving data, when an associated vehicle is in motion. In one implementation, and exemplary system may comprise three central components: 1) a hardware apparatus 10; 2) a device resident component 21 (e.g., downloadable software application) on a user's wireless device 20; and 3) an optional back end server software (notification means 42), that may compile and provide data information about the associated wireless device 20 to an authorized third party located externally of the vehicle.

The apparatus 10 includes a control module 1 strategically mounted within a vehicle passenger compartment 12, such as, beneath a steering wheel 2. The control module 1 may be mounted anywhere within the vehicle passenger compartment 12. In one embodiment, it may be preferred to have the control module 1 mounted in close proximity to a fuse panel (not shown).

The wireless transmission device 5 may be either a radio-frequency (RF) data link or a low-range communication package, such as that commonly marketed and sold under the trademark BLUETOOTH™ 16. The driver's wireless device 20 is loaded with a software application 21 that disables data transmission of data information 44 upon receipt of a discrete wireless signal from the transmission device 5. Examples of data information 44 may include without limitation, email, internet access, and SMS messaging. Furthermore, the software application 21 could be configured to disable other phone features, such as outbound dialing or all data functions. It should be understood that disabling the data information 44 is only temporary. Once the pairing between the software application 21 and the wireless transmission device 5 is broken, blocked data information 44 is delivered to the wireless device 20.

Upon movement of the vehicle, the wireless transmission 5 device sends the wireless signal to the wireless device 20 in order to disable data transmission of data information 44. In order to determine movement of the vehicle, the wireless transmission device 5 works with the wireless device's 20 internal global positioning system (“GPS”) to determine movement of the vehicle. If the accuracy of the phone's GPS system is insufficient, an accelerometer may be installed within the control module to detect movement. In another embodiment, the control module 1 may include a computer 3 or power supply board programmed to control an ultra-sensitive motion sensor 24 and a wireless transmission device 5. The motion sensor 24 may be preferably a wide-area augmentation system (WASS) GPS module 4 that detects even slight vehicle movement.

Accordingly, a driver pairs a discrete wireless device 20 with the control module 1 in a conventional fashion. The pairing could be manual or automatic, but it preferably performed only on the driver's device 20 so that the passengers' devices 20 are unaffected. In one embodiment, when the ignition is activated and the vehicle moves, the GPS will instruct the control computer 3 to transmit the wireless command signal to the paired wireless device 20. Upon receipt of the wireless signal, the software application 21 immediately disables the pertinent communication feature. In one embedment, when the vehicle is stationary, the command signal is disabled and the text-transmission feature is reactivated. In another embodiment, the data transmission may remain deactivated.

Preferably, the software application 21 is protected by a master password that allows a parent or supervisor to control and configure applicable settings. Furthermore, the master password allows access to a voyage log created by the software 21 so that a supervisor can monitor vehicle activity.

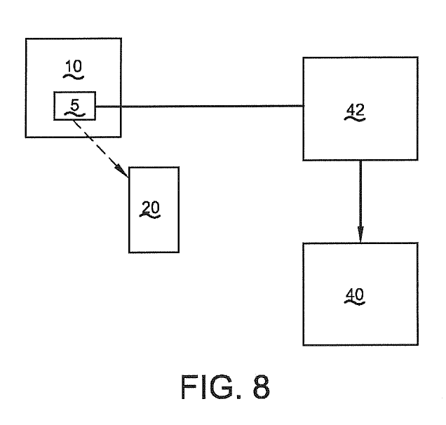

In another embodiment of the techniques and systems described herein, notification means 42 may be utilized with the techniques and systems described herein as shown in FIG. 8. The notification means 42 may take the form of a back end server having software that may include automated text-message and email-transmission capabilities. Upon detection of disablement of the software application 21, the pairing connection or the wireless device 20, the transmission device 5 sends a signal to the notification means 42, which automatically transmits an alert to a second communication device 40, such as a computer or hand held device (wireless phone, tablet or media player). A third party external to the vehicle, such as a parent, fleet manager or supervisor, having the second communication device is able to intercept the alert. The alert may contain any type of information, including but not limited to vehicle speed, vehicle location, interruption of disablement means (pairing connection), curfew violation, and exceeding permitted geographical radius.

The above-described device is not limited to the exact details of construction and enumeration of parts provided herein. Furthermore, the size, shape and materials of construction of the various components can be varied.

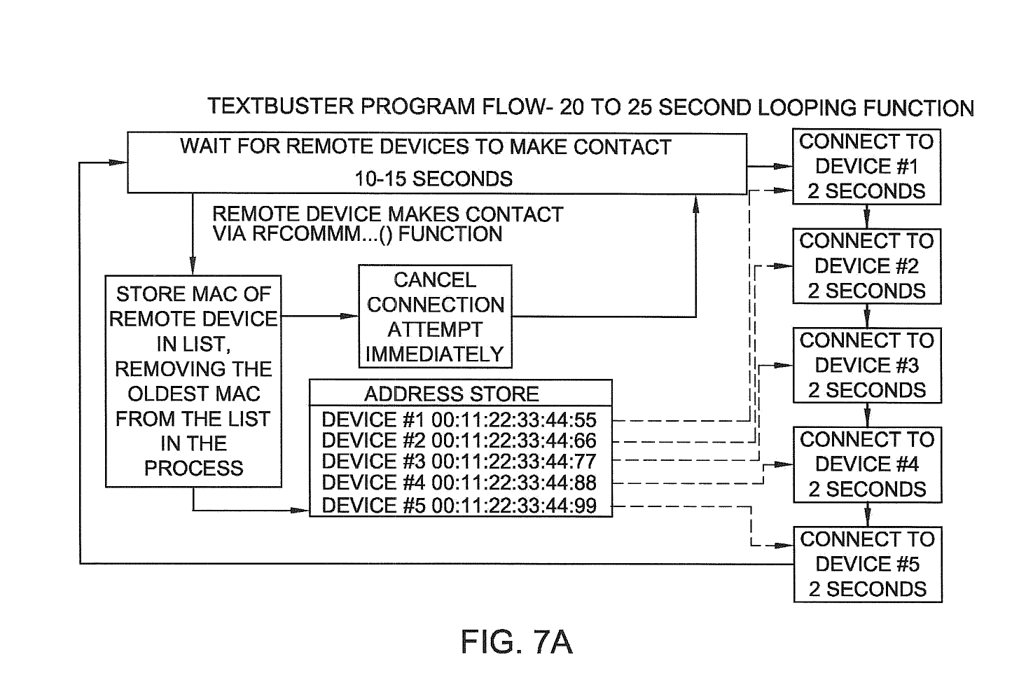

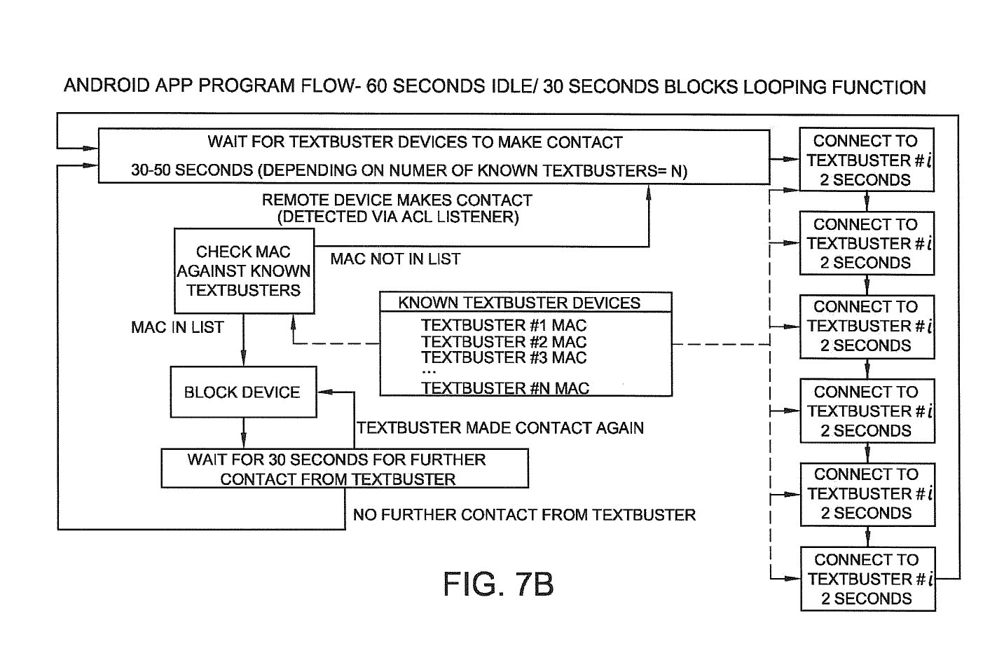

The means for transmitting the signal 14 will now be further described. As previously described, one such example of the signal transmission means is the Bluetooth device 16. With reference to FIGS. 7a and 7b, the transmission device 5 (Bluetooth device 16) may run in an infinite loop, repeating a pattern which is about 20-26 seconds long. Any length of time may be utilized for the infinite loop, for example a ten second loop or a sixty second loop. The pattern alternates between a 10-second long sending phase and a 10 to 16-second long discovery phase. During the sending phase, five 2-second long asynchronous connection-oriented logical transport (“ACL”) connection attempts are made to five different wireless device 20 Bluetooth devices 16. The addresses are stored internally in an address list stored in the control module 1. The apparatus 10 should select the next address which has not been contacted for the longest time.

During the discovery phase, the apparatus waits for about 10-16 seconds for wireless devices 20 running the disabling means 18, such as the software application 21, to make an ACL connection attempt. Once a new device 20 is discovered and its address known to the apparatus 10, the new address is stored in one of the five slots on an internal list while the oldest entry in the list is overwritten with the new one.

The apparatus 10 should stop the pattern and become discoverable for 30 seconds when a button on the apparatus 10 is pressed, so that the software application 21 can determine the address and descriptor (e.g. “Textbuster #3A54B5”) during application setup. After the 30 seconds, the pattern will continue as previously described. If the device has less than five addresses in its list, it will reuse Address 1, 2, . . . to fill the empty time slots in the sending phase.

If the Bluetooth device 16 has contacted the wireless device 20 in the last 30 seconds, the software application 21 will keep the wireless device 20 and Bluetooth device 16 idle awaiting further connection attempts by the Bluetooth device 16.

If the apparatus 10 fails to make a connection attempt for 30 seconds, the software application 21 will proceed with the following looping pattern. The device will try to create an RFCOMM connection with each apparatus 10 whose address it stored. Addresses are configurable via the software application 21 or via discovering the apparatus 10 when it is in its 30 second discoverable mode. The software application 21 will try to connect five apparatuses for 2 seconds each, then repeat this step with the same five addresses, so it hits the time window of the apparatus' discovery phase. The software application 21 will try to send the apparatus' 1-Bluetooth device 16 into idle mode after all apparatuses were contacted twice for the remaining seconds of a full minute. If the software application 21 knows less than five addresses, it will be idle for 2 seconds per empty “Contact Textbuster” slot to preserve battery life.

In summary, the apparatus 10 sends a blocking signal via the Bluetooth device 16 to a person's wireless device 20. This may be done automatically every time the user enters the associated vehicle. The software application 21 downloaded to the wireless device 20 recognized the signal from the apparatus 10 and prevents data information 44 from being used on the wireless device 20. One exception may be the making and receiving of phone calls. The software application 21 may utilize the wireless device's 20 internal GPS software to determine movement of the vehicle. The apparatus 10, via the Bluetooth device 16, may disable a plurality of wireless devices simultaneously. The Bluetooth device 16 attempts to pair a wireless device 20 having the software application 21 at a regular time interval, such as every second.

A system may be devised that can help mitigate use of one or more features of a mobile device, such as a mobile phone, while the user of the device is operating a vehicle, such as a car. As an example, an exemplary system may detect that a target vehicle (e.g., the one operated by the user) is in a driving condition, and send a signal to a paired mobile device to activate a feature activation disabler. Further, as an example, the exemplary system may detect when the target vehicle is in a non-driving condition, and send another signal (e.g., or stop sending the original signal) to the paired mobile device to deactivate the feature activation disabler, thereby allowing the user/operator to access the one or more features on the mobile device.

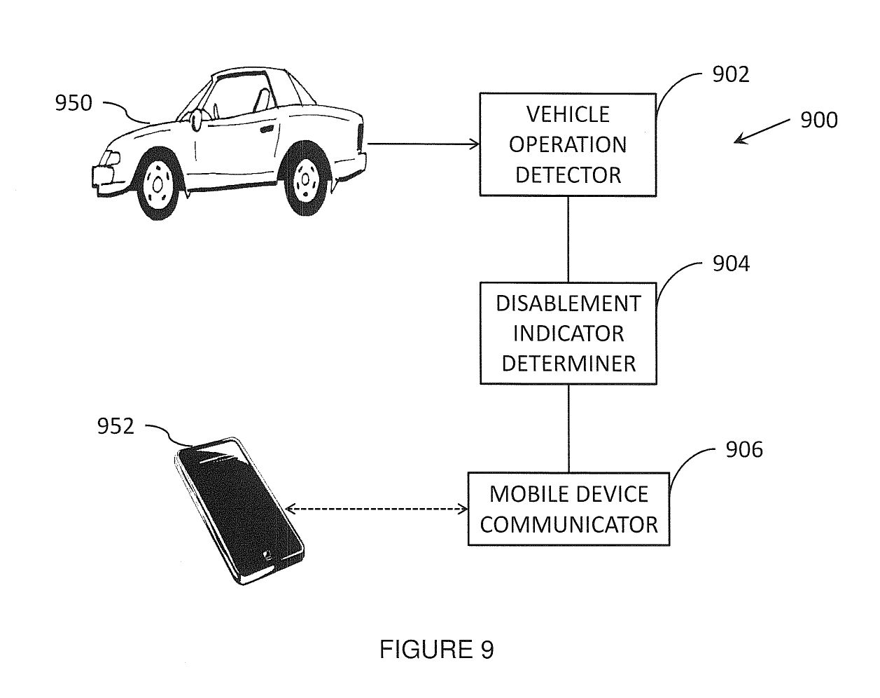

FIG. 9 is a component diagram illustrating an exemplary system 900 for mitigating use of a mobile device feature of a mobile device during vehicle operation. The exemplary system 900 can comprise a control module, comprising a vehicle operation determination component 902 that is operably coupled with a vehicle 950. The operation determination component 902 can be configured to identify a vehicle operation condition. That is, for example, the vehicle operation determination component 902 comprised in the control module may receive a signal from the vehicle that identifies whether the vehicle is in a driving condition or a non-driving condition.

In one implementation, a driving condition may comprise the ignition of the vehicle 950 being disposed in an on condition (e.g., the ignition is turned on, such as by the key); whereas a non-driving condition may comprise the ignition of the vehicle 950 being disposed in an off condition (e.g., turned-off). In one implementation, a driving condition may comprise the transmission of the vehicle 950 being disposed in a moving condition (e.g., shifted into gear, such as drive or reverse, or neutral); whereas a non-driving condition may comprise the transmission of the vehicle 950 being disposed in a non-moving condition (e.g., shifted into park). In one implementation, a driving condition may comprise the engine of the vehicle 950 being disposed in an operating condition (e.g., running); whereas a non-driving condition may comprise the engine of the vehicle 950 being disposed in a non-operating condition (e.g., not-running). In another implementation, a driving condition may comprise the vehicle 950 being disposed in a moving condition (e.g., actually moving); whereas a non-driving condition may comprise the vehicle 950 being disposed in a non-moving condition (e.g., stopped).

In the exemplary system 900, the control module comprises a disablement indicator determination component 904 that is operably coupled with the vehicle operation determination component 902. The disablement indicator determination component 904 is configured to identify a first disablement indicator based at least on the vehicle operation condition, identified by the vehicle operation determination component 902. That is, for example, the disablement indicator determination component 904 may receive an indication that the vehicle 950 is in a driving condition, and generate a first disablement indicator that is indicative of the driving condition of the vehicle (e.g., the car is moving).

In the exemplary system 900, the control module comprises a mobile device communication component 906 that is operably coupled with the disablement indicator determination component 904. The mobile device communication component 906 is configured to communicatively couple with a proximate mobile device 952 and transmit the first disablement indicator to the mobile device 952. As an example, the mobile device communication component 906 may be able to wirelessly identify a proximate (e.g., disposed near-by) mobile device 952 that is transmitting a locator signal (e.g., using Wi-Fi, Bluetooth, or some short-range wireless signal) and pair with the mobile device 952. Alternately, the proximate mobile device may identify the mobile device communication component 906 that is transmitting a locator signal, and pair with the mobile device communication component 906. In one implementation, pairing the mobile device communication component 906 and mobile device 952 may comprise creating a wireless personal area network (WPAN) between them.

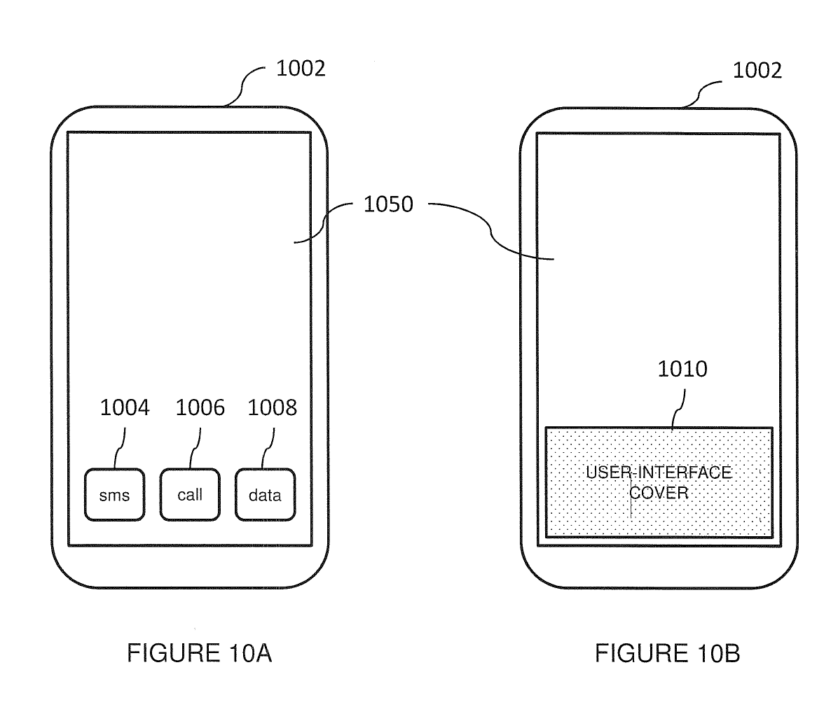

In the exemplary system 900, receipt of said first disablement indicator by the mobile device 952 results in a disablement component, which is operating on the mobile device, enabling a user-interface cover. Further, enabling the user-interface cover mitigates the operator of the mobile device 952 from accessing an activator for a first feature on the mobile device 952. As an illustrative example, FIGS. 10A and 10B are component diagrams illustrating example implementations of one or more portions of one or more systems described herein. In FIG. 10A, an example mobile device 1002 comprises a display 1050, which can comprise one or more feature activators 1004, 1006, 1008. For example, the mobile device 1002 may comprise a display 1050 rendered on a touch-enabled surface, where a user touches the surface of the display to activate a feature activator 1004, 1006, 1008 (e.g., virtual button, icon, object, or widget).

As an example, a feature activator may comprise a text message activator 1004, a phone call activator 1006, and/or a data access activator (e.g., and/or other features). For example, the user of the mobile device 1002 may activate their short-message service (e.g., text-message) application on the mobile device 1002 by touching the display 1050 over the text message activator 1004. As another example, the user of the mobile device 1002 may activate their phone call (e.g., send and/or receive) service application on the mobile device 1002 by touching the display 1050 over the call activator 1006. As another example, the user of the mobile device 1002 may activate their data accessing (e.g., Internet) service application on the mobile device 1002 by touching the display 1050 over the data activator 1008. Further, the display may comprise a plurality of activators (e.g., virtual buttons) that may respectively activate an application or perform some function on the mobile device, for example.

In FIG. 10B, the user-interface (UI) cover 1010 has been activated on the display 1050, for example, where the UI cover 1010 covers over the one or more feature activators 1004, 1006, 1008 on the display 1050. As an example, the mobile device 1002, comprising a touch enabled screen, uses the display 1050 to render the graphical user interface (GUI) for the user, where the GUI can comprise the activators used to interact with the device 1002. That is, for example, the displayed activators may merely be the way a user can activate particular functions on the device 1050. In this way, in this example, by covering the activators 1004, 1006, 1008 with the UI cover 1010 the user may not be able to access the one or more activators (e.g., and thereby not access the associated functions) by touching the screen over the activators 1004, 1006, 1008. In this implementation, for example, the UI cover 1010 may block the user's ability to touch the virtual button beneath, which can block the user from activating the feature (e.g., text message application) associated with the virtual button on the device 1002.

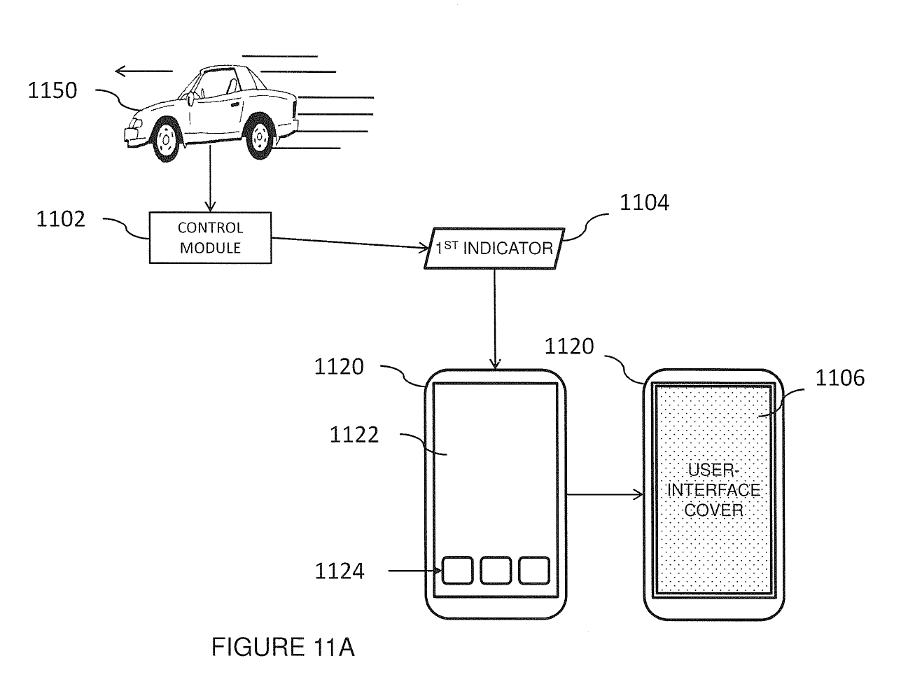

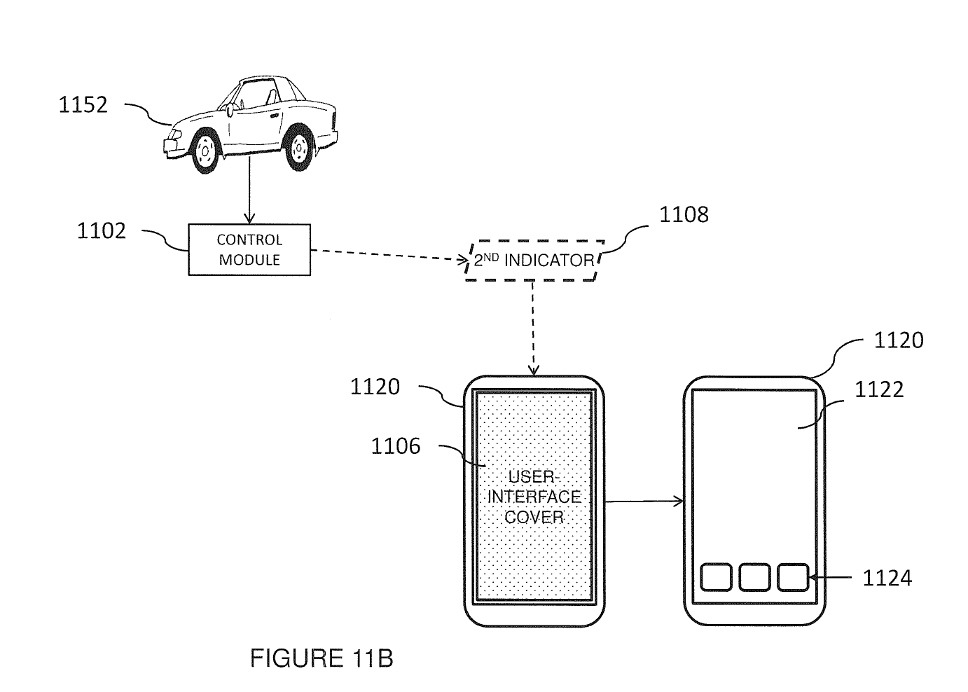

FIGS. 11A and 11B are component diagrams illustrating example implementations of one or more portions of one or more systems described herein. In one implementation, a control module 1102 (e.g., comprising the vehicle operation determination component 902, the disablement indicator determination component 904, and the mobile device communication component 906) may be disposed (e.g., installed) in a target vehicle 1150 (e.g., operator's and/or mobile device user's vehicle). In this implementation, for example, a mobile device 1120 may be communicatively coupled (e.g., paired) with the control module 1102. For example, the mobile device user (e.g., or authorized third-party) may set up the mobile device (e.g., and/or control module) to pair with the control module (e.g., automatically), such as when the mobile device is disposed within a desired range (e.g., within the range of a discrete, short-range signal used to communicate) of the control module (e.g., or vice versa). In one implementation, the mobile device communication component 906 can be configured to couple with the mobile device 1120 and, once coupled, create a personal area network (WPAN) between the control module 1102 and the mobile device 1120.

Further, in this example, when the user enters the target vehicle 1150, comprising the control module 1102, the mobile device communication component 906 comprised in the control module 1102 may communicatively couple with the mobile device 1120. Additionally, in this illustrative example, in FIG. 11A, the mobile phone user may operate the vehicle 1150, thereby placing it in a driving condition, for example, where a driving condition may comprise the vehicle 1150 moving, the ignition turned on, the transmission in gear (e.g., drive, reverse), and/or the motor running. In this example implementation, the control module 1102, operably coupled to the vehicle 1150, can detect the driving condition of the vehicle, generate a first disablement indicator 1104 (e.g., indicative of the vehicle in the driving condition), and transmit the indicator 1104 to a communicatively coupled mobile device 1120.

In one implementation, the vehicle operation determination component 902 comprised in the control module 1102 may be operably coupled (e.g., wired or wirelessly linked) to: an on-board diagnostic system (OBDS) of the vehicle 1150; an ignition system of the vehicle 1150; a transmission of the vehicle 1150; a navigation system of the vehicle 1150; a global positioning system; an electrical system of the vehicle 1150; and/or a power train control module of the vehicle 1150. In this implementation, for example, a signal received from one or more of the components of the vehicle 1150 may be sent to the vehicle operation determination component 902, thereby indicating whether the vehicle is in a driving mode, or a non-driving mode. As an example, the vehicle OBDS can identify whether the vehicle is turned on, running, and/or moving, and a signal indicating such can be sent to the operably coupled control module 1102.

In the example implementation of FIG. 11A, upon receipt of the first indicator 1104, a disablement component, comprising one or more mobile device programs running on the mobile device 1120, can generate the UI cover 1106. In one implementation, the UI cover 1106 can comprise a graphical display rendered on the display 1122 of the mobile device 1120 that is configured to cover over one or more interactive user-interface components, such as the feature activators 1124. For example, the display 1122 of the mobile device 1120 may render a plurality of activators 1124, which are respectively used to activate a feature on the mobile device 1120, such as text messaging, phone calls, data access, etc. In this example implementation, the UI Cover 1106 can comprise a graphical object that is rendered on the display 1122, for example, effectively covering the displayed activators 1124, and mitigating their activation by the user (e.g., by touching the virtual button).

In FIG. 11B, the disablement indicator determination component 904, comprised in the control module 1102, can be configured to identify a second disablement indicator 1108. Further, in this implementation, the second disablement indicator 1108 can comprise an indication that the vehicle 1152 is in a non-driving condition. For example, when the user/operator bring the vehicle 1150 to a stop, shuts off the engine, and/or turns off the ignition, the vehicle may be considered to be in a non-driving condition. Additionally, in this example, the vehicle operation determination component 902 may receive a signal indicative of the vehicle's non-driving condition. The disablement indicator determination component 904 can generate the second disablement indicator 1108, for example, which can be transmitted to the mobile device 1120 by the mobile device communication component 906. In this implementation, upon receipt of the second disablement indicator 1108 by the mobile device 1120, the disablement component on the mobile device 1120 can disable the user-interface cover 1106. In this way, for example, the user may be able to access the one or more activators 1124 rendered on the mobile device display 1122.

In one implementation, when the vehicle 1150 is disposed in a non-driving condition, the disablement indicator determination component 904 may no longer identify the first disablement indicator 1104 (e.g., no driving condition indication received by vehicle operation determination component 902). In this implementation, the mobile device communication component 906 may be configured to cease transmission of the first disablement indicator 1104 to the mobile device. Further, in this implementation, cessation of receipt of the first disablement indicator 1104 by the mobile device 1120 may result in the disablement component disabling the user-interface cover 1106.

That is, for example, when the vehicle 1150 is in a driving condition, the mobile device communication component 906 may continuously (e.g., or periodically) send the first disablement indicator 1104 to the mobile device 1120. In turn, in this example, the disablement component on the mobile device 1120 may maintain the UI cover 1106 in place on the display 1122. When the vehicle 1150 is disposed in a non-driving condition, the mobile device communication component 906 may stop sending the first disablement indicator 1104 to the mobile device 1120, resulting in the disablement component on the mobile device 1120 non longer maintaining the UI cover 1106 on the display 1122.

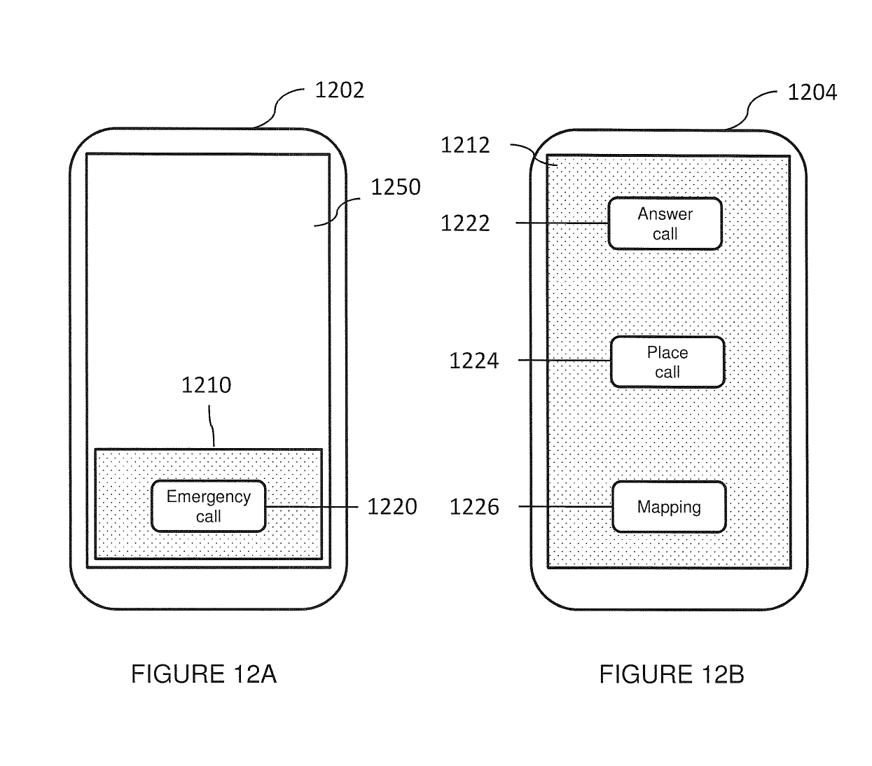

In one aspect, the UI cover operated by the disablement component on the mobile device may be configured to comprise one or more alternate feature activators, which can be activated by a user of the mobile device. FIGS. 12A and 12B are component diagrams illustrating example implementations of one or more portions of one or more systems described herein. In one implementation, in this aspect, the UI cover 1210 can comprises an alternate feature activator 1220 that is configured to be activated by an operator of the mobile device 1202. As an illustrative example, the UI cover 2010 rendered on the display 1250 of the mobile device 1202, may comprise an “emergency call” activator 1220. for example, the activator 1220 may be used to place an emergency call if needed by the user, for example, as the UI cover 1210 may effectively block the user from accessing the mobile device's phone call application.

In one implementation, as illustrated in FIG. 12B, the UI cover 1212 can be configured to comprise a plurality of alternate feature activators 1222, 1224, 1226. For example, the plurality of alternate activators may comprise a call answering activator 1222, a call placement activator 1224, and/or a mapping activator (e.g., to activate a GPS enabled map program), and others. In one implementation, the user-interface cover 1212 may be configurable by an authorized user to comprise one or more desired alternate feature activators. For example, the authorized user of the mobile device may be able to configure the user-interface cover 1212 to cover a desired portion (e.g., some or all) of the mobile device display 1250, and/or may be able to select (e.g., or create) one or more alternate activators 1222, 1224, 1226 to be used on the UI cover 1212, when enabled on the mobile device 1204.

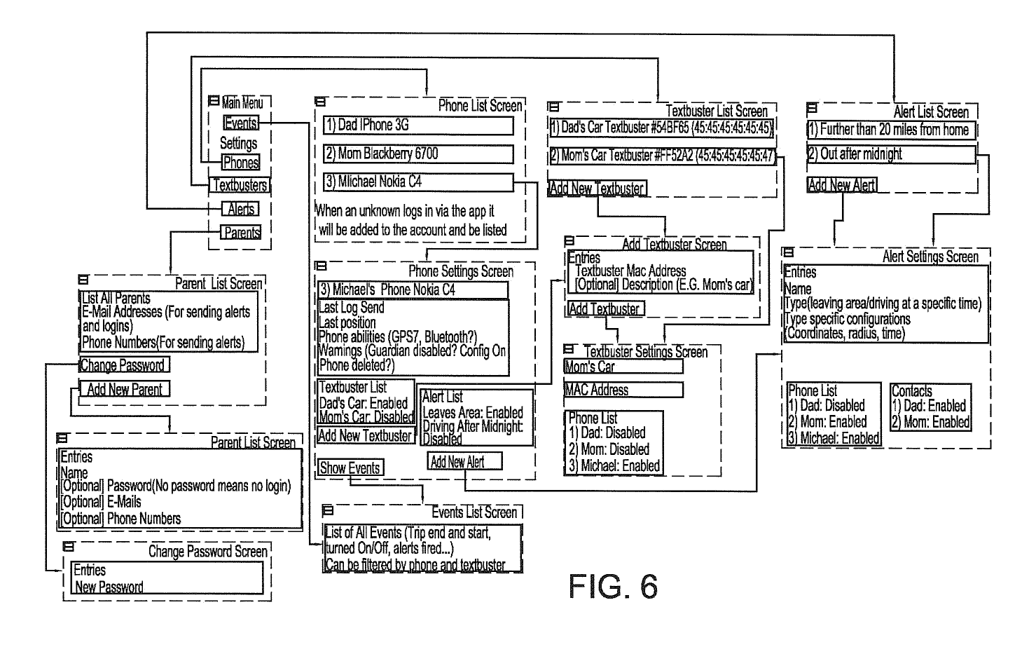

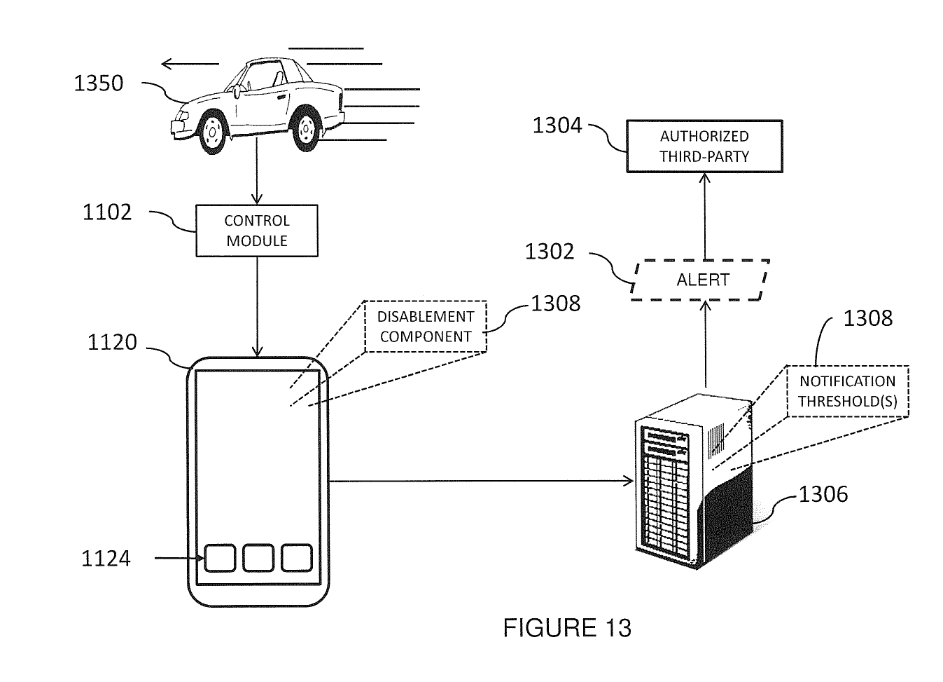

In one implementation, as described above, and with reference to FIGS. 6 and 13, the disablement component 1308 operating on the mobile device 1120 can be configured to cause an alert 1302 to be sent to a desired third-party 1304 if at least a portion of the disablement component 1308 is deactivated without authorization. That is, for example, if the disablement component 1308 is deactivated on the mobile device 1120, a user of the mobile device may be able to access the one or more feature activators 1124 while the target vehicle 1350 is in a driving condition. In this example, the control module 1102 may send the first disablement indicator to the mobile device, but the UI cover may not be enabled due to the disablement component 1308 being deactivated. In this implementation, the mobile device may send a notification to the authorized third-party (e.g., parent of mobile device user) that alerts them to the deactivation of the disablement component 1308.

In one implementation, the mobile device 1120 can be communicatively coupled (e.g., over Wi-Fi, cellular, etc.) with a remote notification component 1306, comprising one or more authorized third-party notification thresholds 1308. In one implementation, the remote notification component 1306 may comprise a remote (e.g., cloud-based) computing component (e.g., server) that is configured to receive data from the mobile device 1120 indicative of: a location of said mobile device; a speed of said mobile device; a vehicle operation condition of said vehicle; an operation condition of said disablement component; and/or an operation state of said mobile device. Further, the remote notification component can be configured to send a notification 1302 to the authorized third-party 1304 if one or more notification thresholds 1308 are met.

In one implementation, the one or more notification thresholds 1308 can be configurable by the authorized third-party 1304, and the one or more notification thresholds 1308 may comprise: a vehicle operation time threshold, such as a period of time during which the vehicle 1350 may be operated in a driving condition; a vehicle geographic location range threshold, such as an area in which the vehicle 1350 may be operated in a driving condition; a vehicle speed threshold, such as a top speed for the vehicle 350 in a driving condition; and/or a vehicle condition threshold, such as a driving or non-driving condition for the vehicle 350.

As an example, the authorized third-party 1304 may wish to be notified when the target vehicle 1350 strays out of a desired geographic area, is operated above a desired speed limit, is operated past a desired time, and/or is driven at all. In this example, the authorized third-party 1304 may configure the one or more notification thresholds 1308 disposed on the notification component 1306, such as by accessing a network based application (e.g., Internet web-site) to set the threshold limits. Further, in this example, the mobile device can be configured (e.g., programmatically) to automatically send a notification to the notification component 1306 (e.g., wirelessly) when one or more of the notification thresholds 1308 have been met (e.g., passed, above and/or below, outside of the range); which, in-turn may send an alert 1302 to the authorized third party 1304. As another example, the mobile device may be configured to send (e.g., periodically or continuously) telemetric data (e.g., speed, location, operation, etc.) to the notification component 1306, which may determine whether one or more of the notification thresholds 1308 have been met.

A method may be devised for helping to mitigate a user of a mobile device from using one or more features of the mobile device while operating a vehicle. In one implementation, the operation condition of a target vehicle may be detected to determine whether it is in a driving condition. If the vehicle is being operated in a driving condition, a signal indicative of the vehicle in a driving condition can be transmitted to a proximate mobile device that is paired with communication component disposed in the vehicle. Sending the signal to the mobile device may result in access to mobile device features being blocked on the mobile device. Further, in one implementation, when the vehicle is in a non-driving condition, another signal can be sent (e.g., or stopping sending the original signal) to the paired mobile device to deactivate the feature blocking, thereby allowing the user/operator to access the one or more features on the mobile device.

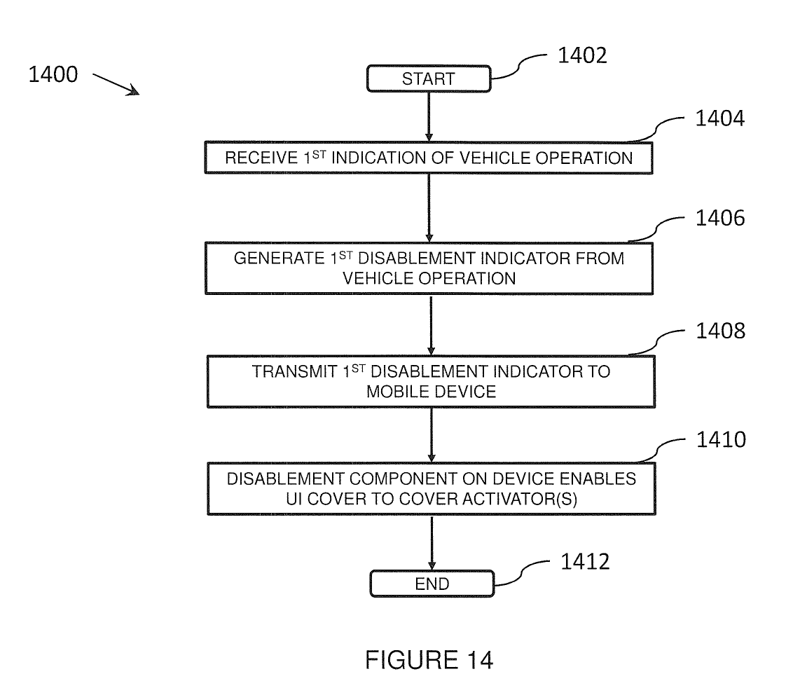

FIG. 14 is a flow diagram illustrating an exemplary method 1400 for mitigating use of a mobile device feature of a mobile device during vehicle operation. The exemplary method 1400 begins at 1402 and involves receiving a first indication of vehicle operation using a signal detector that is operably coupled to a vehicle, at 1404. As an example, when the vehicle is placed in a driving condition, such as turning the ignition on, starting the engine, moving the vehicle, putting it in gear, etc., the signal detector may receive a signal that is indicative of the vehicle being placed into the driving condition. At 1406, a first disablement indicator can be generated, based at least upon the first indication of vehicle operation, using a disablement indicator generation component that is operably coupled with the signal detector. For example, the vehicle operation signal may be converted into a first disablement indicator, indicating that the vehicle is in a driving condition.

At 1408 of the exemplary method 1400, the first disablement indicator can be transmitted to a proximate mobile device using a mobile device communicator that is communicatively coupled with the mobile device and operably coupled with the disablement indicator generation component. As an example, the mobile device communicator may be paired with a proximate mobile device when the mobile device is disposed within a range of a shirt-range communication signal. In this example, upon pairing, a wireless personal area network may be created between the mobile device and the mobile device communicator disposed in the vehicle. Further, for example, the operably coupled disablement indicator generation component may send the first disablement indicator to the mobile device communicator, which can transmit it to the paired mobile device.

At 1410, upon receipt of the first disablement indicator by said mobile device, a disablement component that is operating on the mobile device can enable a user-interface (UI) cover. Enabling of the UI cover can mitigate a mobile device operator accessing an activator for a first feature on said mobile device. As an example, the UI cover can comprise a user interface graphic that substantially covers over the targeted activators (e.g., virtual buttons) that are displayed on the display of a touch enabled mobile device. In this way, for example, the user of the mobile device may not be able to access (e.g., touch) the one or more activators to activate the associated feature, such as short-message service (SMS) (e.g., texting), phone call service, and/or data service (e.g., Internet). Having activated the UI cover on the mobile device, the exemplary method 1400 ends at 1412.

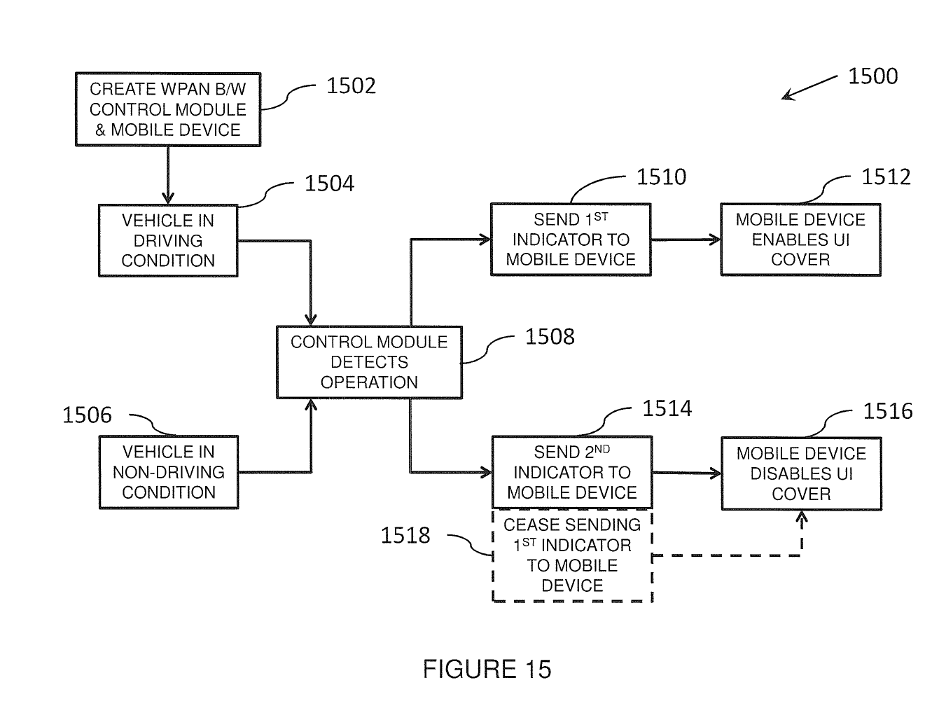

FIG. 15 is a flow diagram illustrating an example method 1500 where one or more portions of techniques described herein may be implemented. In the example implementation 1500, at 1502, a short-range, wireless, personal area network (WPAN) can be created between a mobile device communicator and a mobile device that is disposed in a target vehicle. When the vehicle is placed into a driving condition by the vehicle operator, at 1504, a control module disposed in (e.g., or on) the target vehicle can detect the vehicle operation condition (e.g., moving), at 1508.

In one implementation, the control module may be operably coupled with the vehicle, for example, such that a signal detector disposed in the control module is configured to receive a vehicle operation signal from one or more components of the vehicle. For example, the control module may be operably coupled (e.g., wired or wirelessly linked) with: an on-board diagnostic system (OBDS) of the vehicle; an ignition system of the vehicle; a transmission of the vehicle; a navigation system of the vehicle; a global positioning system; an electrical system of the vehicle; and/or a power train control module of the vehicle. In this example, the signal detector may receive first indication of vehicle operation from one or more of these components, indicating that the vehicle is in a driving condition.

At 1510 of the example method 1500, the first indication of vehicle operation can be transmitted to the communicatively coupled mobile device. At 1512, upon receiving the first indication of vehicle operation, the mobile device (e.g., a disablement component disposed therein) can enable the UI cover, for example, thereby blocking the user's ability to activate one or more of the mobile phone features.

In one implementation, at 1506, the vehicle may be subsequently disposed in a non-driving condition, such as stopped, turned off, put in park, etc. In this implementation, the control module may detect the vehicle operation condition, where the signal detector receives a second indication of vehicle operation. At 1514, the control module can transmit a second disablement indicator, indicative of the second indication of vehicle operation, to the paired mobile device. At 1516, upon receipt of the second disablement indicator, the disablement component running on the mobile device can disable the UI cover; thereby allowing the user of the device to access the one or more mobile device feature activators, for example.

In one implementation, upon receiving the second indication of vehicle operation, at 1508, the control module can cease transmitting the first disablement indicator to the paired mobile device, at 1518. Further, at 1516, cessation of receipt of the first disablement indicator by the mobile device may result in the disablement component disabling the user-interface cover. That is, for example, when the control module detects the vehicle is in a driving condition, the it can continuously (e.g., or periodically) send the first disablement indicator to the mobile device. In this example, when the vehicle is placed in a non-driving condition, the control module may stop sending the first disablement indicator to the mobile device 1120, resulting in the disablement component on the mobile device no longer maintaining the UI cover on the display.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of the techniques and systems described herein. It is intended to include all such modifications and alterations in so far as they come within the scope of the appended claims or the equivalents thereof.

What is claimed is:

1. A control module, comprising:
a vehicle operation determination component, operably coupled with a vehicle, and configured to identify a vehicle operation condition;
a disablement indicator determination component, operably coupled with said vehicle operation determination component, and configured to identify a first disablement indicator based at least on said vehicle operation condition; and
a mobile device communication component, operably coupled with said disablement indicator determination component, and configured to:
communicatively couple with a proximate mobile device; and
transmit said first disablement indicator to said mobile device, wherein:
receipt of said first disablement indicator by said mobile device results in a disablement component operating on said mobile device enabling a user-interface cover; and
enabling said user-interface cover mitigates a mobile device operator accessing an activator for a first feature on said mobile device.

2. The control module of claim 1, wherein said vehicle operation condition comprises one of:
a driving condition, comprising one or more of:
an ignition of said vehicle in an on condition;
a transmission of said vehicle in a moving condition;
an engine of said vehicle in an operating condition; and
said vehicle in a moving condition; and
a non-driving condition, comprising one or more of:
an ignition of said vehicle in an off condition;
a transmission of said vehicle in a non-moving condition;
an engine of said vehicle in a non-operating condition; and
said vehicle in a non-moving condition.

3. The control module of claim 2, wherein:
said first disablement indicator comprises an indication that the vehicle is in a driving condition;
said disablement indicator determination component is configured to identify a second disablement indicator; and
said second disablement indicator comprises an indication that the vehicle is in a non-driving condition.

4. The control module of claim 3, wherein said mobile device communication component is configured to transmit said second disablement indicator to said mobile device, wherein receipt of said second disablement indicator by said mobile device results in said disablement component disabling said user-interface cover.

5. The control module of claim 1, wherein said mobile device communication component is configured to cease transmission of said first disablement indicator to said mobile device upon said disablement indicator determination component not identifying said first disablement indicator, wherein cessation of receipt of said first disablement indicator by said mobile device results in said disablement component disabling said user-interface cover.

6. The control module of claim 1, wherein said disablement component comprises one or more mobile device programs executed on said mobile device, at least in part, by a processing unit.

7. The control module of claim 1, wherein said user-interface cover comprises a graphical display on a screen of said mobile device configured to cover an interactive user-interface component.

8. The control module of claim 1, wherein said user-interface cover comprises an alternate feature activator configured to be activated by said operator.

9. The control module of claim 8, where said alternate feature activator comprises one or more of:
an call placement activator; and
a call answering activator.

10. The control module of claim 8, wherein said user-interface cover can be configured by an authorized user to comprise one or more desired alternate feature activators.

11. The control module of claim 1, wherein said mobile device communication component is configured to perform one or more of:
communicatively couple with one or more proximate mobile devices using a discrete, short-range wireless signal; and
create a personal area network between said mobile device communication component and said one or more mobile devices using said short-range wireless signal.

12. The control module of claim 1, wherein said disablement component operating on said mobile device is configured to cause an alert to be sent to a desired third-party if at least a portion of said disablement component is deactivated without authorization.

13. The system of claim 1, wherein said mobile device is communicatively coupled with a remote notification component, comprising one or more authorized third-party notification thresholds, said remote notification component configured to:
receive data from said mobile device indicative of one or more of:
a location of said mobile device;
a speed of said mobile device;
a vehicle operation condition of said vehicle;
an operation condition of said disablement component; and
an operation state of said mobile device; and
send a notification to said authorized third-party if one or more notification thresholds are met.

14. The control module of claim 13, wherein said one or more notification thresholds are configurable by said authorized third-party, wherein said one or more notification thresholds comprise one or more of:
a vehicle operation time threshold;
a vehicle geographic location range threshold;
a vehicle speed threshold; and
a vehicle condition threshold.

15. A method for mitigating use of a mobile device feature of a mobile device during vehicle operation, comprising:
receiving a first indication of vehicle operation using a signal detector operably coupled to a vehicle;
generating a first disablement indicator based at least upon said first indication of vehicle operation using a disablement indicator generation component operably coupled with said signal detector;
transmitting said first disablement indicator to a proximate mobile device using a mobile device communicator communicatively coupled with said mobile device and operably coupled with said disablement indicator generation component, wherein:
receipt of said first disablement indicator by said mobile device results in a disablement component operating on said mobile device enabling a user-interface cover; and
enabling said user-interface cover mitigates a mobile device operator accessing an activator for a first feature on said mobile device.

16. The method of claim 15, comprising creating a short-range, wireless, personal area network between said mobile device communicator and said mobile device in said vehicle.

17. The method of claim 15, comprising:
receiving a second indication of vehicle operation using said signal detector; and
performing one of:
transmitting a second disablement indicator to said mobile device based at least upon said second indication of vehicle operation, wherein receipt of said second disablement indicator by said mobile device results in said disablement component disabling said user-interface cover; and
ceasing transmission of said first disablement indicator to said mobile device based at least upon said second indication of vehicle operation, wherein cessation of receipt of said first disablement indicator by said mobile device results in said disablement component disabling said user-interface cover.

18. The method of claim 17, wherein:
said first indication of vehicle operation comprises an indication that said vehicle is in a driving condition; and
said second indication of vehicle operation comprises an indication that said vehicle is in a non-driving condition.

19. The method of claim 1, wherein receiving said first indication of vehicle operation using said signal detector comprises receiving said first indication of vehicle operation from one or more of:
an on-board diagnostic system of said vehicle;
an ignition system of said vehicle;
a transmission of said vehicle;
a navigation system of said vehicle;
a global positioning system;
an electrical system of said vehicle; and
a power train control module of said vehicle.

20. A system for mitigating use of a mobile device feature during vehicle operation, comprising:
a control component operably coupled with a vehicle, and communicatively coupled with a proximate mobile device using a short-range wireless personal area network, said control component configured to:
receive a first indication of a vehicle operation state, comprising a driving condition, and receive a second indication of a vehicle operation state, comprising a non-driving condition, from one of:
an on-board diagnostic system of said vehicle;
an ignition system of said vehicle;
a transmission of said vehicle;
a navigation system of said vehicle;
a global positioning system of said vehicle;
an electrical system of said vehicle; and
a power train control module of said vehicle;
transmit said first indication and said second indication to said mobile device, wherein:
receipt of said first indication by said mobile device results in a disablement component operating on said mobile device enabling a user-interface cover; and
enabling said user-interface cover mitigates a mobile device operator accessing an activator for a first feature on said mobile device; and
receipt of said second indication by said mobile device results in said disablement component disabling said user-interface cover; and
said disablement component is configured to cause an alert to be sent to a desired third-party if at least a portion of said disablement component is deactivated without authorization.
